(19) United States
(12) Patent Application Publication
(10) Pub. No.: US 2025/0196936 A1
(43) Pub. Date: Jun. 19, 2025

(54) JOINT STRUCTURE OF VEHICLE BODY

(71) Applicants: Hyundai Motor Company, Seoul (KR); Kia Corporation, Seoul (KR)

(72) Inventors: Cheol Han Park, Hwaseong-si (KR); SunKi Choi, Hwaseong-si (KR)

(21) Appl. No.: 18/828,574

(22) Filed: Sep. 9, 2024

(30) Foreign Application Priority Data
Dec. 13, 2023 (KR) 10-2023-0180571

(51) Int. Cl. B62D 27/06; B60R 13/02; B60R 13/06; B62D 25/04; B62D 25/20; B62D 63/02

(52) U.S. Cl. CPC B62D 27/065; B60R 13/0212; B60R 13/025; B60R 13/06; B62D 25/04; B62D 25/20; B62D 63/025

(57) ABSTRACT

An embodiment joint structure of a vehicle body includes a front body module fixed to a front part of an under body, wherein the front body module is a fixed part, a rear body module detachably coupled to a rear part of the under body and the front body module, wherein the rear body module is a variable part having any predetermined shape of a plurality of predetermined shapes, a fixed part joint beam connected to the front body module, a variable part joint beam connected to the rear body module, and a joint unit including a block, wherein the fixed part joint beam and the variable part joint beam are inserted in the block in a front-to-back direction of the vehicle body, and the joint unit engages with the fixed part joint beam and the variable part joint beam.

### CROSS-REFERENCE TO RELATED APPLICATIONS

This application claims the benefit of Korean Patent Application No. 10-2023-0180571, filed on Dec. 13, 2023, which application is hereby incorporated herein by reference.

### TECHNICAL FIELD

The present invention relates to a vehicle body.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. This PBV can provide various customized services to users while moving from the starting point to the destination in a manned or an unmanned autonomous driving method.

The vehicle body of such a PBV includes an under body (also referred to as a rolling chassis or a skateboard in the art) and an upper body assembled to the under body.

Here, the upper body may be configured in various forms according to the type of customized service of the PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

The PBV can only be used as a hailing or delivery vehicle, but if users can change its purpose, the vehicle's usage time can increase significantly.

In other words, if the vehicle's purpose can be easily changed, the front cabin of the vehicle, including the driver's seat of the upper body, and the under body are made of a common configuration, and if the rear of the upper body is configured to be easily replaceable, the vehicle usability can be increased while reducing costs.

Matters described in this background section are prepared to enhance understanding of the background of embodiments of the invention and may include matters other than the already known prior art.

### SUMMARY

The present invention relates to a vehicle body. Particular embodiments relate to a joint structure that can be applied to the production of various body types.

Embodiments of the present disclosure provide a joint structure of a vehicle body that can be easily changed into various types of vehicle bodies to increase the usability of the PBV.

A joint structure of a vehicle body according to an embodiment may include a front body module as a fixed part fixed to a front part of an under body, a rear body module as a variable part detachable to a rear part of the under body and the front body module in a predetermined shape, a fixed part joint beam connected to the front body module, a variable part joint beam connected to the rear body module, and a joint unit in a form of a block in which the fixed part joint beam and the variable part joint beam are inserted in the front-to-back direction of the vehicle body and engages with the fixed part joint beam and the variable part joint beam.

Each of the fixed part joint beam and the variable part joint beam may include a body engage portion having a closed cross-section and a block engage portion that extends in a rib shape from the body engage portion to fit into the joint unit and engages with the joint unit.

The joint unit may include a main joint block that connects the fixed part joint beam and the variable part joint beam in the front-to-back direction of the vehicle body and a corner joint block that connects one end of the fixed part joint beam and the variable part joint beam in the front-to-back direction of the vehicle body.

The main joint block may be formed in an ‘H’ cross-section shape.

The main joint block may include a main joint channel formed on each side so that the block engage portion is fitted in the front-to-back direction of the vehicle body.

The corner joint block may include a first block part of an ‘H’ cross-section shape that connects the ends of the fixed part joint beam and the variable part joint beam disposed along the vehicle width direction in the front-to-back direction of the vehicle body and a second block part of an ‘H’ cross-section shape extending from the first block part to connect the ends of the fixed part joint beam and the variable part joint beam disposed along the vertical direction in the front-to-back direction of the vehicle body.

The first block part may include a first joint channel formed along the vehicle width direction on each side.

The second block part may include a second joint channel formed along the vertical direction on each side.

The first block part may be engaged along the vehicle body vertical direction to the fixed part joint beam and the variable part joint beam through fastening members.

The second block part may be engaged along the vehicle width direction to the fixed part joint beam and the variable part joint beam through fastening members.

The fixed part joint beam may be connected to a fixed part side structure, a fixed part roof structure, and a fixed part floor structure of the front body module, respectively.

The variable part joint beam may be connected to a variable part side structure, a variable part roof structure, and a variable part floor structure of the rear body module, respectively.

The fixed part roof structure may include a fixed part roof rail and a fixed part roof panel connected to each other.

The variable part roof structure may include a variable part roof rail and a variable part roof panel connected to each other.

The body engage portion may be engaged with the fixed part roof rail and the variable part roof rail through fastening members.

The main joint block, the block engage portion, the fixed part roof rail, the variable part roof rail, the fixed part roof panel, and the variable part roof panel may engage through fastening members.

A roof weather strip may be mounted on roof flange portions formed on each of the fixed part roof panel and the variable part roof panel.

A roof molding member may be mounted between the fixed part roof panel and the variable part roof panel.

The fixed part floor structure may include a fixed part floor panel.

The variable part floor structure may include a variable part floor panel.

The body engage portion may be engaged to the fixed part floor panel and the variable part floor panel through fastening members.

The main joint block, the block engage portion, the fixed part floor panel, and the variable part floor panel may engage through fastening members.

A floor weather strip may be mounted on floor flange portions formed on each of the fixed part floor panel and the variable part floor panel.

An under cover may be connected to the fixed part floor panel and the variable part floor panel.

The fixed part side structure may include a fixed part pillar assembly.

The variable part side structure may include a variable part pillar assembly.

The body engage portion may be engaged with the fixed part pillar assembly and the variable part pillar assembly along the vehicle width direction and front-to-back direction of the vehicle body through fastening members.

The main joint block, the block engage portion, the fixed part pillar assembly, and the variable part pillar assembly may engage along the vehicle width direction through fastening members.

A side weather strip may be mounted on side flange portions formed on each of the fixed part pillar assembly and the variable part pillar assembly.

A side molding member may be mounted between the fixed part pillar assembly and the variable part pillar assembly.

According to the joint structure of a vehicle body according to embodiments of the present invention, the PBV can be easily changed into various types of vehicle bodies to increase the usability of the PBV and reduce the manufacturing cost of the PBV.

In addition, effects that can be obtained or expected due to embodiments of the present invention will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are for reference in explaining exemplary embodiments of the present invention, the technical ideas of the embodiments of the present invention should not be construed as being limited to the accompanying drawings.

FIG. 1 is a block diagram showing a joint structure of a vehicle body according to an embodiment.

FIG. 2 to FIG. 4 are cut-away perspective views illustrating the joint structure of a vehicle body according to an embodiment.

FIG. 5 is a perspective view illustrating a fixed part joint beam and a variable part joint beam applied to the joint structure of a vehicle body according to an embodiment.

FIG. 6 is a perspective view illustrating a main joint block of a joint unit applied to the joint structure of a vehicle body according to an embodiment.

FIG. 7 is a cross-sectional view along line A-A of FIG. 3.

FIG. 8 is a cross-sectional view along line B-B of FIG. 4.

FIG. 9 is a cross-sectional view along line C-C of FIG. 4.

FIG. 10 and FIG. 11 are drawings illustrating corner joint blocks of the joint unit applied to a joint structure of a vehicle body according to an embodiment.

The following reference identifiers may be used in connection with the drawings to describe various features of embodiments of the present invention.

1: under body
3: upper body
10: front body module
10a: fixed part
11: fixed part side structure
13: fixed part pillar assembly
14, 44: side flange portion
21: fixed part roof structure
23: fixed part roof rail
25: fixed part roof panel
26, 56: roof flange portion
31: fixed part floor structure
33: fixed part floor panel
34, 64: floor flange portion
40: rear body module
40a: variable part
41: variable part side structure
43: variable part pillar assembly
51: variable part roof structure
53: variable part roof rail
55: variable part roof panel
61: variable part floor structure
63: variable part floor panel
100: joint structure of a vehicle body
110: fixed part joint beam
111, 211: body engage portion
113, 213: closed cross-section
131, 231: block engage portion
210: variable part joint beam
310: joint unit
311: main joint block
313: main joint channel
331: corner joint block
351: first block part
353: first joint channel
371: second block part
373: second joint channel
411: roof weather strip
413: roof molding member
431: floor weather strip
433: under cover
451: side weather strip
453: side molding member
511-513, 611-614, 711-715, 811-812: fastening member

The drawings referenced above are not necessarily drawn to scale, but they should be understood as presenting a somewhat simplified representation of various preferred features illustrating the basic principles of embodiments of the present invention. The specific design features of the embodiments, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement embodiments of the present invention. As those skilled in the art would realize, the described embodiments may be modified in various different ways, all without departing from the spirit or scope of the embodiments of the present invention.

The terminology used herein is for the purpose of describing specific embodiments only and is not intended to limit the embodiments. As used herein, singular forms are intended to also include plural forms, unless the context clearly indicates otherwise.

In addition, in the detailed description below, the names of the components are divided into first, second, etc. to distinguish them when the components are in a similar relationship, and the description below is not necessarily limited to that order.

As used herein, the terms ‘comprise’ and/or ‘comprising’ indicate the presence of specified features, integers, steps, operations, elements, and/or components, but may also include one or more other features, integers, or steps. It should also be understood that this does not exclude the presence or addition of elements, operations, components, and/or groups thereof.

As used herein, the term ‘and/or’ includes any one or all combinations of one or more items listed in association.

In this specification, the term ‘connected’ indicates a physical relationship between two components in which the components are directly connected to each other by welding, rivets, self piercing rivet (SPR), flow drill screw (FDS), structural adhesive, etc., or indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

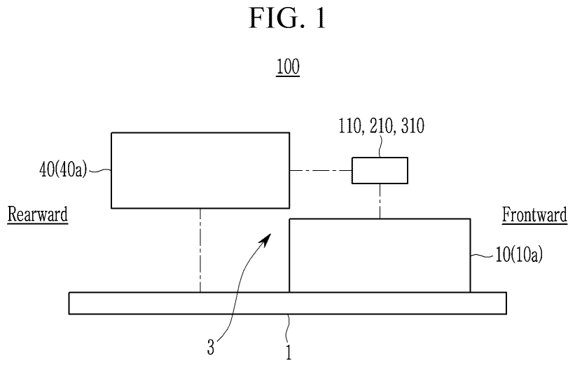

FIG. 1 is a block diagram showing a joint structure of a vehicle body according to an embodiment.

Referring to FIG. 1, a vehicle body to which a joint structure 100 according to an embodiment can be applied may be, for example, a purpose-based mobility vehicle (Purpose Built Vehicle: hereinafter referred to as ‘PBV’).

The PBV can be utilized as an electric car-based life module vehicle that provides various customized services to users during the time it takes to move from the departure point to the destination.

As an example, the PBV can be manufactured as a 1 box type design with a wide interior space. Furthermore, the PBV may have facing-type seats applied to the interior space.

The vehicle body of this PBV is suitable for small-quantity production of various vehicle types with a small number of parts and can be manufactured in various shapes and sizes.

Furthermore, the vehicle body of the PBV includes a skateboard type under body 1, (which is also commonly referred to as a ‘rolling chassis’ or ‘chassis frame’ by those skilled in the art) and an upper body 3 assembled to the under body 1.

The under body 1 can accommodate components such as a battery assembly and a drive motor. And the upper body 3 is a body in white (BIW) body that is connected to the under body 1 and may include a cabin and luggage room with a wide interior space.

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The joint structure 100 according to an embodiment is a structure that may apply the upper body 3 of various shapes and purposes to the under body 1 according to the type of customized service of the PBV.

The joint structure 100 according to an embodiment includes the upper body 3 assembled to the under body 1 and including a front body module 10 and a rear body module 40.

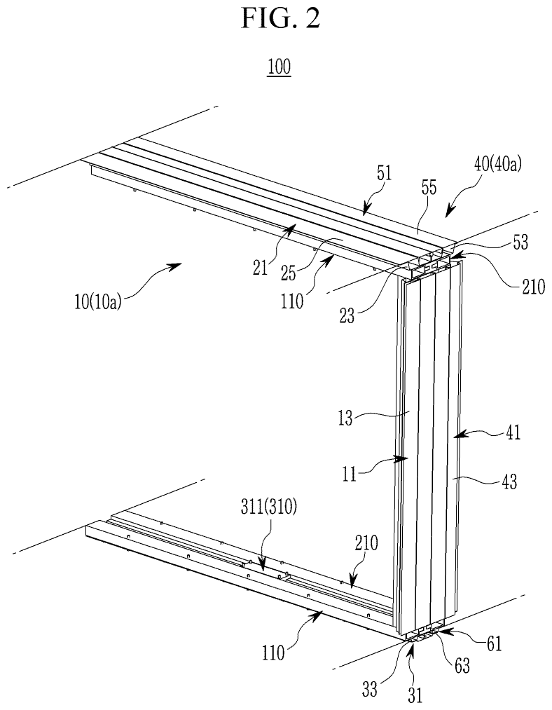

FIG. 2 to FIG. 4 are partially cut-away perspective views illustrating the joint structure of a vehicle body according to an embodiment. FIG. 2 to FIG. 4 illustrate one side of the vehicle body, the rear portion of the front body module 10, and the front portion of the rear body module 40.

Referring to FIG. 1 to FIG. 4, in an embodiment, the front body module 10 includes a front cabin of a cab type. The front body module 10 may be fixed to the front part of the under body 1.

The front body module 10 may be mounted to the front part of the under body 1 along the vertical direction via a vehicle body mounting unit known to a person of ordinary skill in the art. The front body module 10 may be a fixed part (fixed portion) 10a fixed to the front part of the under body 1. The fixed part 10a is a component connected to the under body 1 and represents a component that is not to be replaced even if the intended use of the vehicle changes.

The front body module 10 includes a fixed part side structure 11, a fixed part roof structure 21, and a fixed part floor structure 31, which are connected to each other.

The fixed part side structure 11 is provided on each side of the front body module 10 in the vehicle width direction. The fixed part roof structure 21 connects the upper part of the fixed part side structures 11 along the vehicle width direction. The fixed part floor structure 31 connects the lower part of the fixed part side structures 11 along the vehicle width direction.

The fixed part side structure 11 includes a fixed part pillar assembly 13. The fixed part roof structure 21 includes a fixed part roof rail 23 and a fixed part roof panel 25 that are connected to each other. Additionally, the fixed part floor structure 31 includes a fixed part floor panel 33.

The rear body module 40 includes a rear cabin or luggage room. The rear body module 40 can be connected to the rear part of the under body 1.

The rear body module 40 can be connected to the rear part of the under body 1 via a vehicle body mounting unit known to a person of ordinary skill in the art. The rear body module 40 is a component that can be replaced (or detached) depending on the vehicle's intended use and represents a variable part (replaceable portion) 40a.

The rear body module 40 includes a variable part side structure 41, a variable part roof structure 51, and a variable part floor structure 61.

The variable part side structure 41 is provided on each side of the rear body module 40 in the vehicle width direction. The variable part roof structure 51 connects the upper portion of the variable part side structures 41 along the vehicle width direction. The variable part floor structure 61 connects the lower portion of the variable part side structures 41 along the vehicle width direction.

The variable part side structure 41 includes a variable part pillar assembly 43.

The variable part roof structure 51 includes a variable part roof rail 53 and a variable part roof panel 55 that are connected to each other.

The variable part floor structure 61 includes a variable part floor panel 63.

The joint structure 100 according to an embodiment provides a structure that can be commonly applied to various types of vehicles. Various vehicle types mean various configurations of the variable part 40a, and can be, for example, a hailing vehicle as a means of transporting occupants, a delivery vehicle for transporting goods, and special vehicles such as ambulances.

Referring to FIG. 2 to FIG. 4, the joint structure 100 according to an embodiment includes a fixed part joint beam 110, a variable part joint beam 210, and a joint unit 310.

The fixed part joint beam 110 is connected to the fixed part side structure 11, the fixed part roof structure 21, and the fixed part floor structure 31 of the front body module 10, respectively.

The fixed part joint beam 110 is disposed along the vertical direction in the fixed part side structure 11 and along the vehicle width direction in the fixed part roof structure 21 and the fixed part floor structure 31.

The variable part joint beam 210 is connected to the variable part side structure 41, the variable part roof structure 51, and the variable part floor structure 61 of the rear body module 40, respectively.

The variable part joint beam 210 is disposed along the vertical direction in the variable part side structure 41 and along the vehicle width direction in the variable part roof structure 51 and the variable part floor structure 61.

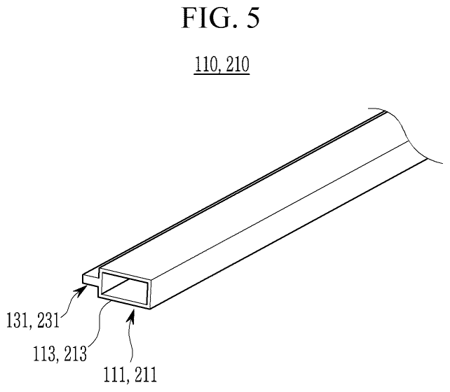

FIG. 5 is a perspective view illustrating a fixed part joint beam and a variable part joint beam applied to the joint structure of a vehicle body according to an embodiment.

Referring to FIG. 2 to FIG. 5, each of the fixed part joint beam 110 and the variable part joint beam 210 according to an embodiment includes body engage portions 111 and 211 and block engage portions 131 and 231, respectively.

The body engage portion 111 of the fixed part joint beam 110 is connected to the fixed part side structure 11, the fixed part roof structure 21, and the fixed part floor structure 31 of the front body module 10.

The body engage portion 211 of the variable part joint beam 210 is connected to the variable part side structure 41, the variable part roof structure 51, and the variable part floor structure 61 of the rear body module 40.

The body engage portions 111 and 211 include closed cross-sections 113 and 213, respectively, formed along the length direction. In one example, the closed cross-sections 113 and 213 can be formed into a rectangular cross-section shape.

The block engage portions 131 and 231 are configured to engage with the joint unit 310, which will be described later. The block engage portions 131 and 231 extend in a rib shape from the body engage portions 111 and 211, respectively, and can engage with the joint unit 310.

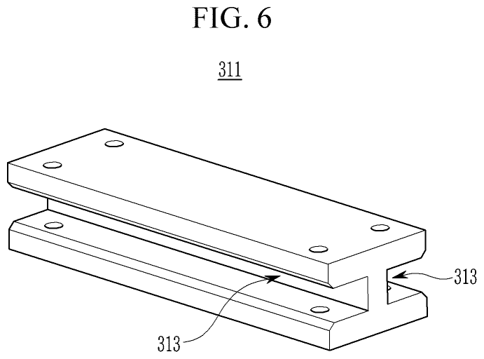

FIG. 6 is a perspective view illustrating a main joint block of a joint unit applied to the joint structure of a vehicle body according to an embodiment.

Referring to FIG. 2 to FIG. 6, in an embodiment, the joint unit 310 is configured to connect the fixed part joint beam 110 and the variable part joint beam 210 along the front-to-back direction of the vehicle body.

The fixed part joint beam 110 and the variable part joint beam 210 can be engaged with the joint unit 310 along the front-to-back direction of the vehicle body.

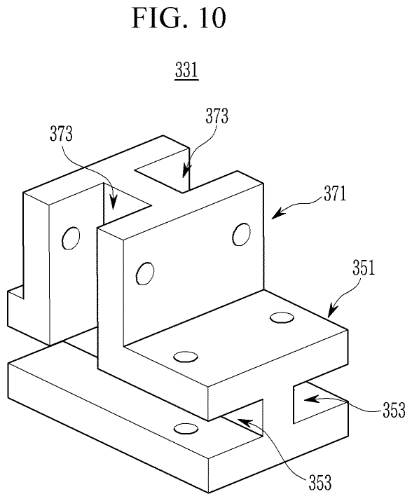

The joint unit 310 includes a main joint block 311 and a corner joint block 331 (see FIG. 10).

The main joint block 311 can connect the middle portion of the fixed part joint beam 110 and the variable part joint beam 210 along the front-to-back direction of the vehicle body.

As shown in FIG. 6, the main joint block 311 can be provided as a block with an ‘H’ cross-section shape. The main joint block 311 includes main joint channels 313 formed on each side.

The main joint channel 313 may be fitted with the block engage portions 131 and 231 of the fixed part joint beam 110 and the variable part joint beam 210 along the front-to-back direction of the vehicle body. And the main joint block 311 can be engaged with the block engage portions 131 and 231 fitted into the main joint channel 313.

The corner joint block 331 can connect corners of the fixed part joint beam 110 and the variable part joint beam 210 in the front-to-back direction of the vehicle body.

The configuration of the corner joint block 331 will be described in detail later.

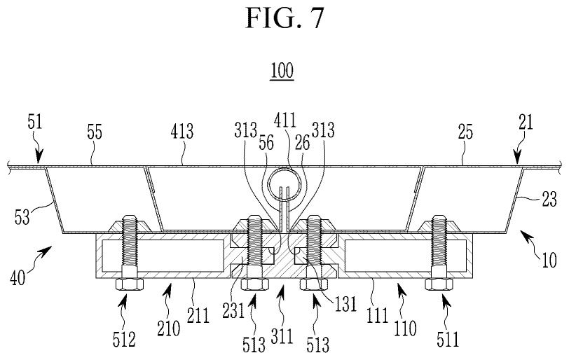

Hereinafter, the connection structure of the front body module 10 and the rear body module 40 applied to the joint structure 100 according to an embodiment will be described in detail, referring to FIG. 7 to FIG. 9.

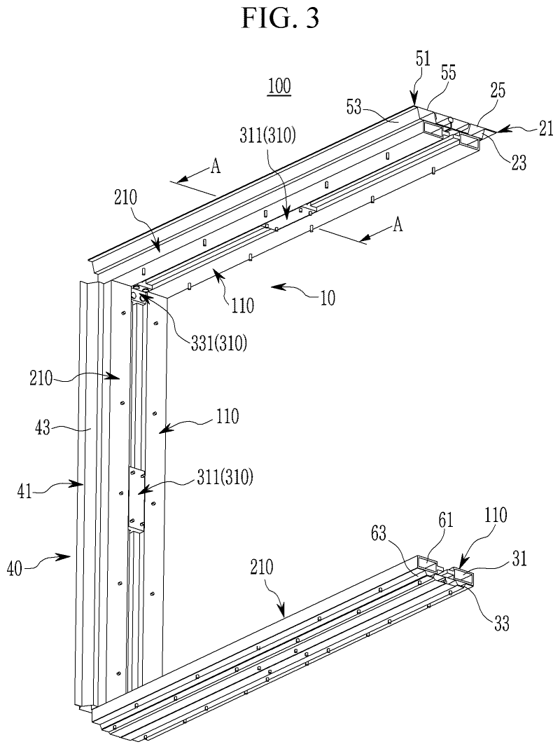

FIG. 7 is a cross-sectional view along line A-A of FIG. 3.

Referring to FIG. 7, in an embodiment, the fixed part roof structure 21 of the front body module 10 and the variable part roof structure 51 of the rear body module 40 can be connected along the front-to-back direction of the vehicle body by the fixed part joint beam 110, the variable part joint beam 210, and the main joint block 311.

The body engage portion 111 of the fixed part joint beam 110 can be engaged along the vehicle body vertical direction to the fixed part roof rail 23 of the fixed part roof structure 21 via a fastening member 511.

The body engage portion 211 of the variable part joint beam 210 can be engaged along the vehicle body vertical direction to the variable part roof rail 53 of the variable part roof structure 51 via a fastening member 512.

The block engage portions 131 and 231 of the fixed part joint beam 110 and variable part joint beam 210, respectively, are inserted into the main joint channel 313 of the main joint block 311 along the front-to-back direction of the vehicle body.

The main joint block 311 and the block engage portions 131 and 231 can be engaged along the vehicle body vertical direction via fastening members 513. The fastening members 513 are engaged to the fixed part roof rail 23 and the fixed part roof panel 25 and can be engaged to the variable part roof rail 53 and the variable part roof panel 55.

The fastening members 511, 512, and 513 may include a combination of a bolt and a nut.

Roof flange portions 26 and 56 are formed on each of the fixed part roof panel 25 and the variable part roof panel 55, respectively, and a roof weather strip 411 is mounted on the roof flange portions 26 and 56.

A roof molding member 413 is mounted between the fixed part roof panel 25 and the variable part roof panel 55.

The roof weather strip 411 and the roof molding member 413 are configured to seal between the fixed part roof structure 21 and the variable part roof structure 51. The roof molding member 413 may pressurize the roof weather strip 411.

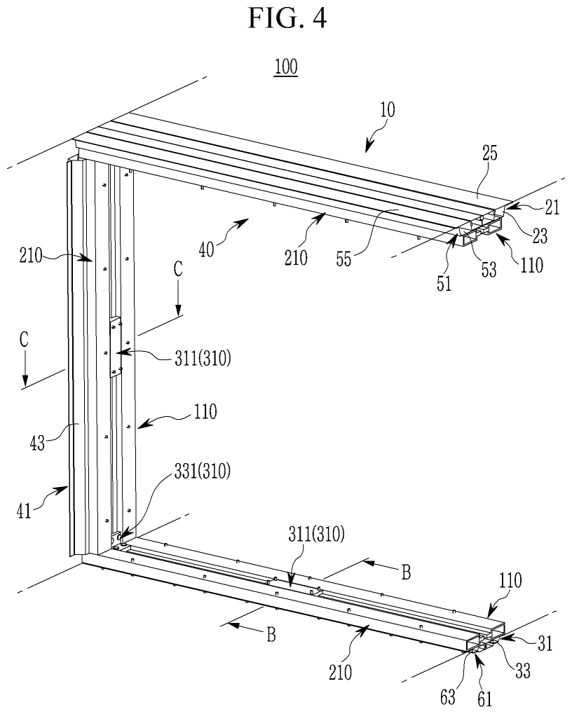

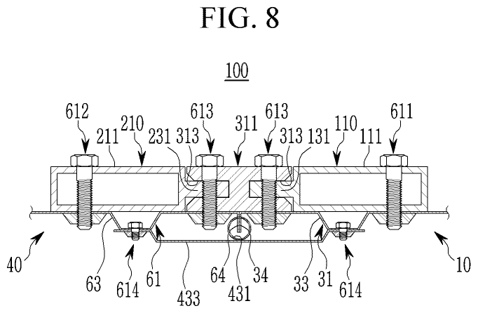

FIG. 8 is a cross-sectional view along line B-B of FIG. 4.

Referring to FIG. 8, in an embodiment, the fixed part floor structure 31 of the front body module 10 and the variable part floor structure 61 of the rear body module 40 can be connected along the front-to-back direction of the vehicle body by the fixed part joint beam 110, the variable part joint beam 210, and the main joint block 311.

The body engage portion 111 of the fixed part joint beam 110 can be engaged along the vehicle body vertical direction to the fixed part floor panel 33 of the fixed part floor structure 31 via a fastening member 611.

The body engage portion 211 of the variable part joint beam 210 can be engaged along the vehicle body vertical direction to the variable part floor panel 63 of the variable part floor structure 61 via a fastening member 612.

The block engage portions 131 and 231 of the fixed part joint beam 110 and the variable part joint beam 210, respectively, are inserted into the main joint channel 313 of the main joint block 311 along the front-to-back direction of the vehicle body.

The main joint block 311 and the block engage portions 131 and 231 can be engaged along the vehicle body vertical direction via fastening members 613. The fastening members 613 may engage the fixed part floor panel 33 and the variable part floor panel 63.

Floor flange portions 34 and 64 are formed on each of the fixed part floor panel 33 and the variable part floor panel 63, respectively, and a floor weather strip 431 is mounted on the floor flange portions 34 and 64.

An under cover 433 is connected to the fixed part floor panel 33 and the variable part floor panel 63. The under cover 433 can be engaged to the fixed part floor panel 33 and the variable part floor panel 63 via fastening members 614.

The floor weather strip 431 and the under cover 433 are configured to seal between the fixed part floor structure 31 and the variable part floor structure 61. The under cover 433 may pressurize the floor weather strip 431.

The fastening members 611, 612, 613, and 614 may include a combination of a bolt and a nut.

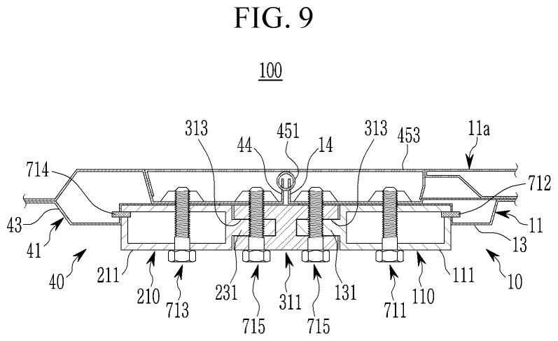

FIG. 9 is a cross-sectional view along line C-C of FIG. 4.

Referring to FIG. 9, in an embodiment, the fixed part side structure 11 of the front body module 10 and the variable part side structure 41 of the rear body module 40 can be connected along the front-to-back direction of the vehicle body by the fixed part joint beam 110, the variable part joint beam 210, and the main joint block 311.

The body engage portion 111 of the fixed part joint beam 110 can be engaged along the vehicle width direction to the fixed part pillar assembly 13 of the fixed part side structure 11 via a fastening member 711. The body engage portion 111 of the fixed part joint beam 110 can be engaged to the fixed part pillar assembly 13 along the front-to-back direction of the vehicle body via a fastening member 712.

The body engage portion 211 of the variable part joint beam 210 can be engaged along the vehicle width direction to the variable part pillar assembly 43 of the variable part side structure 41 via a fastening member 713. The body engage portion 211 of the variable part joint beam 210 can be engaged along the front-to-back direction of the vehicle body to the variable part pillar assembly 43 via a fastening member 714.

The block engage portions 131 and 231 of the fixed part joint beam 110 and the variable part joint beam 210, respectively, are inserted into the main joint channel 313 of the main joint block 311 along the front-to-back direction of the vehicle body.

The main joint block 311 and the block engage portions 131 and 231 can be engaged along the vehicle width direction via fastening members 715. The fastening members 715 are engaged to the fixed part pillar assembly 13 and to the variable part pillar assembly 43.

The fastening members 711, 712, 713, 714, and 715 may include a combination of a bolt and a nut.

Side flange portions 14 and 44 are formed on each of the fixed part pillar assembly 13 and the variable part pillar assembly 43, respectively, and a side weather strip 451 is mounted on the side flange portions 14 and 44.

A side molding member 453 is mounted between the fixed part pillar assembly 13 and the variable part pillar assembly 43.

The side weather strip 451 and the side molding member 453 are configured to seal between the fixed part side structure 11 and the variable part side structure 41. The side molding member 453 may pressurize the side weather strip 451.

Drawing reference numeral 11a represents a front door assembly of the fixed part side structure 11.

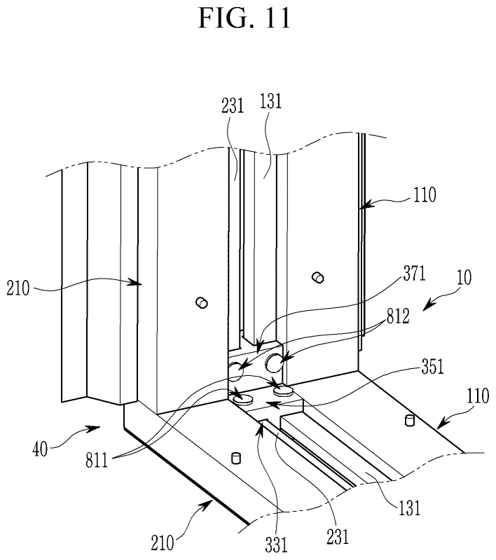

FIG. 10 and FIG. 11 are drawings illustrating a corner joint block of the joint unit applied to the joint structure of a vehicle body according to an embodiment.

Referring to FIG. 2 to FIG. 4, FIG. 10 and FIG. 11, the corner joint block 331 according to an embodiment includes a first block part 351 and a second block part 371.

The first block part 351 is configured to connect the ends of the fixed part joint beam 110 and the variable part joint beam 210 disposed along the vehicle width direction along the front-to-back direction of the vehicle body. The first block part 351 may be provided as a block with an ‘H’ cross-section shape.

The first block part 351 includes a first joint channel 353 formed along the vehicle width direction on each side. The first joint channel 353 can accommodate the block engage portions 131 and 231 of the fixed part joint beam 110 and the variable part joint beam 210, respectively, disposed along the vehicle width direction.

The second block part 371 is configured to connect the ends of the fixed part joint beam 110 and the variable part joint beam 210 disposed along the vehicle body vertical direction along the front-to-back direction of the vehicle body.

The second block part 371 extends from the first block part 351 and may be provided as a block with an ‘H’ cross-section shape. The second block part 371 includes a second joint channel 373 formed along the vertical direction on each side.

The second joint channel 373 can be fitted with the block engage portions 131 and 231 of the fixed part joint beam 110 and the variable part joint beam 210 disposed along the vertical direction.

The first block part 351 can be engaged along the vehicle body vertical direction via fastening members 811 to the block engage portions 131 and 231 of the fixed part joint beam 110 and the variable part joint beam 210 disposed along the vehicle width direction.

The second block part 371 can be engaged along the vehicle width direction via fastening members 812 to the block engage portions 131 and 231 of the fixed part joint beam 110 and the variable part joint beam 210 disposed along the vertical direction.

The second block part 371 may be configured in a vertical direction from the first block part 351.

The fastening members 811 and 812 may include a combination of a bolt and a nut.

Hereinafter, the assembly process and operation of the joint structure 100 according to an embodiment configured as above will be described in detail.

Referring to FIG. 1 to FIG. 11, in an embodiment, the under body 1 of the vehicle body is provided.

And, as the upper body 3 to be assembled to the under body 1, the front body module 10 and the rear body module 40 are provided.

The front body module 10 includes the fixed part side structure 11, the fixed part roof structure 21, and the fixed part floor structure 31. The rear body module 40 includes the variable part side structure 41, the variable part roof structure 51, and the variable part floor structure 61.

In the front body module 10, the fixed part joint beam 110 is engaged with each of the fixed part side structure 11, the fixed part roof structure 21, and the fixed part floor structure 31.

Additionally, in the rear body module 40, the variable part joint beam 210 is engaged with each of the variable part side structure 41, the variable part roof structure 51, and the variable part floor structure 61.

Each of the fixed part joint beam 110 and the variable part joint beam 210 respectively includes the body engage portions 111 and 211 and the block engage portions 131 and 231.

The body engage portion 111 of the fixed part joint beam 110 is engaged with the fixed part roof rail 23 of the fixed part roof structure 21, the fixed part floor panel 33 of the fixed part floor structure 31, and the part pillar assembly 13 of the fixed part side structure 11.

And the body engaging portion 211 of the variable part joint beam 210 is engaged with the variable part roof rail 53 of the variable part roof structure 51, the variable part floor panel 63 of the variable part floor structure 61, and the variable part pillar assembly 43 of the variable part side structure 41.

In this state, the front body module 10 is connected to the front part of the under body 1 along the vertical direction. The front body module 10 may be equipped with the fixed part 10a that is fixed to the front part of the under body 1 by a vehicle body mounting unit.

The rear body module 40 having various shapes depending on the intended use is disposed on the rear part of the under body 1.

The main joint block 311 and the corner joint block 331 of the joint unit 310 are provided. The corner joint block 331 includes the first block part 351 and the second block part 371 connected to each other.

The block engage portions 131 and 231 of the fixed part joint beam 110 and variable part joint beam 210, respectively, are inserted into the main joint channel 313 of the main joint block 311 along the front-to-back direction of the vehicle body.

Simultaneously, the block engage portions 131 and 231 of the fixed part joint beam 110 and the variable part joint beam 210 disposed along the vehicle width direction are fitted into the first joint channel 353 of the first block part 351.

Additionally, the block engage portions 131 and 231 of the fixed part joint beam 110 and the variable part joint beam 210 disposed along the vertical direction are fitted into the second joint channel 373 of the second block part 371.

In this state, the main joint block 311, the block engage portions 131 and 231, the fixed part roof rail 23, the fixed part roof panel 25, the variable part roof rail 53, and the variable part roof panel 55 are engaged by the fastening member 513 (see FIG. 7).

And the main joint block 311, the block engage portions 131 and 231, the fixed part floor panel 33, and the variable part floor panel 63 are engaged by the fastening member 613 (see FIG. 8).

Additionally, the main joint block 311, the block engage portions 131 and 231, the fixed part pillar assembly 13, and the variable part pillar assembly 43 are engaged by the fastening member 715 (see FIG. 9).

The first block part 351 is engaged with the block engage portions 131 and 231 of the fixed part joint beam 110 and the variable part joint beam 210 disposed along the vehicle width direction via the fastening member 811 (see FIG. 11).

The second block part 371 is engaged along the vertical direction to the block engage portions 131 and 231 of the fixed part joint beam 110 and the variable part joint beam 210 via the fastening members 812 (see FIG. 11).

In this state, the roof weather strip 411 is mounted on the roof flange portions 26 and 56 of the fixed part roof panel 25 and the variable part roof panel 55, and the roof molding member 413 is mounted between the fixed part roof panel 25 and the variable part roof panel 55 (see FIG. 7).

The floor weather strip 431 is mounted on the floor flange portions 34 and 64 of the fixed part floor panel 33 and the variable part floor panel 63, respectively, and the under cover 433 is engaged on the fixed part floor panel 33 and the variable part floor panel 63 (see FIG. 8).

Additionally, the side weather strip 451 is mounted on the side flange portions 14 and 44 of the fixed part pillar assembly 13 and the variable part pillar assembly 43, respectively, and the side molding member 453 is mounted between the fixed part pillar assembly 13 and the variable part pillar assembly 43 (see FIG. 9).

The rear body module 40 is connected to the rear of the under body 1 along the vehicle body vertical direction. The rear body module 40 is connected in the vertical direction to the rear of the under body 1 by a vehicle body mounting unit. The rear body module 40 can be equipped with the variable part 40a connected to the rear part of the front body module 10.

According to an embodiment of the joint structure 100 as described so far, the front body module 10 as the fixed part 10a connected to the front part of the under body 1 can be left as is, and the rear body module 40 as the variable part 40a can be connected to the rear part of the under body 1 and the front body module 10.

Therefore, the joint structure 100 according to an embodiment can replace the rear body module 40 of a predetermined shape according to the type of customized service (e.g., use case) of the PBV.

Accordingly, the joint structure 100 according to an embodiment can easily change the structure of the upper body 3 of the vehicle body depending on the purpose of use of the PBV, and the manufacturing cost of the PBV can be reduced.

Additionally, according to an embodiment of the joint structure 100, the fixed part joint beam 110, the variable part joint beam 210, the main joint block 311, and the corner joint block 331 may be manufactured from aluminum extrusions, in one example.

Accordingly, the joint structure 100 according to an embodiment can reduce the weight of the PBV.

Furthermore, the joint structure 100 according to an embodiment includes the corner joint block 331 connecting the corner of the fixed part joint beam 110 and the variable part joint beam 210. The fixed part joint beam 110 and the variable part joint beam 210 include the closed cross-sections 113 and 213, respectively.

Therefore, the joint structure 100 according to an embodiment can secure the joint strength and connection robustness of the front body module 10 and the rear body module 40.

Furthermore, the joint structure 100 according to an embodiment includes the roof weather strip 411, the roof molding member 413, the floor weather strip 431, the under cover 433, the side weather strip 451, and the side molding member 453.

Thus, the joint structure 100 according to an embodiment can secure the watertight performance of the PBV.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A joint structure of a vehicle body, the joint structure comprising:
a front body module fixed to a front part of an under body, wherein the front body module is a fixed part;
a rear body module detachably coupled to a rear part of the under body and the front body module, wherein the rear body module is a variable part having any predetermined shape of a plurality of predetermined shapes;
a fixed part joint beam connected to the front body module;
a variable part joint beam connected to the rear body module; and
a joint unit comprising a block, wherein the fixed part joint beam and the variable part joint beam are inserted in the block in a front-to-back direction of the vehicle body, and the joint unit engages with the fixed part joint beam and the variable part joint beam.

2. The joint structure of claim 1, wherein each of the fixed part joint beam and the variable part joint beam comprises:
a body engage portion having a closed cross-section; and
a block engage portion that extends in a rib shape from the body engage portion to fit into the joint unit and engages with the joint unit.

3. The joint structure of claim 2, wherein the joint unit comprises:
a main joint block that connects the fixed part joint beam and the variable part joint beam in the front-to-back direction of the vehicle body; and
a corner joint block that connects an end of the fixed part joint beam and an end of the variable part joint beam in the front-to-back direction of the vehicle body.

4. The joint structure of claim 3, wherein the main joint block has an ‘H’ cross-section shape.

5. The joint structure of claim 3, wherein the main joint block comprises a main joint channel disposed on each side so that the block engage portion is fitted in the front-to-back direction of the vehicle body.

6. The joint structure of claim 3, wherein the corner joint block comprises:
a first block part having an ‘H’ cross-section shape that connects the end of the fixed part joint beam and the end of the variable part joint beam disposed along a vehicle width direction in the front-to-back direction of the vehicle body; and
a second block part having an ‘H’ cross-section shape extending from the first block part to connect the end of the fixed part joint beam and the end of the variable part joint beam disposed along a vertical direction in the front-to-back direction of the vehicle body.

7. The joint structure of claim 6, wherein:
the first block part comprises a first joint channel disposed along the vehicle width direction on each side; and
the second block part comprises a second joint channel disposed along the vertical direction on each side.

8. The joint structure of claim 6, wherein:
the first block part is engaged along the vertical direction to the fixed part joint beam and the variable part joint beam through first fastening members; and
the second block part is engaged along the vehicle width direction to the fixed part joint beam and the variable part joint beam through second fastening members.

9. The joint structure of claim 3, wherein:
the fixed part joint beam is connected to a fixed part side structure, a fixed part roof structure, and a fixed part floor structure of the front body module; and
the variable part joint beam is connected to a variable part side structure, a variable part roof structure, and a variable part floor structure of the rear body module.

10. The joint structure of claim 9, wherein:
the fixed part roof structure comprises a fixed part roof rail and a fixed part roof panel connected to each other;
the variable part roof structure comprises a variable part roof rail and a variable part roof panel connected to each other;
the body engage portion engages with the fixed part roof rail and the variable part roof rail through first fastening members; and
the main joint block, the block engage portion, the fixed part roof rail, the variable part roof rail, the fixed part roof panel, and the variable part roof panel are engaged through second fastening members.

11. The joint structure of claim 10, further comprising:
a roof weather strip mounted on roof flange portions disposed on each of the fixed part roof panel and the variable part roof panel; and
a roof molding member mounted between the fixed part roof panel and the variable part roof panel.

12. The joint structure of claim 9, wherein:
the fixed part floor structure comprises a fixed part floor panel;
the variable part floor structure comprises a variable part floor panel;
the body engage portion is engaged to the fixed part floor panel and the variable part floor panel through first fastening members; and
the main joint block, the block engage portion, the fixed part floor panel, and the variable part floor panel are engaged through second fastening members.

13. The joint structure of claim 12, further comprising:
a floor weather strip mounted on floor flange portions disposed on each of the fixed part floor panel and the variable part floor panel; and
an under cover connected to the fixed part floor panel and the variable part floor panel.

14. The joint structure of claim 9, wherein:
the fixed part side structure comprises a fixed part pillar assembly;
the variable part side structure comprises a variable part pillar assembly;
the body engage portion is engaged with the fixed part pillar assembly and the variable part pillar assembly along a vehicle width direction and the front-to-back direction of the vehicle body through first fastening members; and
the main joint block, the block engage portion, the fixed part pillar assembly, and the variable part pillar assembly are engaged along the vehicle width direction through second fastening members.

15. The joint structure of claim 14, further comprising:
a side weather strip mounted on side flange portions disposed on each of the fixed part pillar assembly and the variable part pillar assembly; and
a side molding member mounted between the fixed part pillar assembly and the variable part pillar assembly.

16. A vehicle comprising:
a vehicle body comprising an under body and an upper body disposed on the under body, wherein the upper body comprises:
a front body module fixed to a front part of the under body, wherein the front body module is a fixed part and comprises a fixed part side structure, a fixed part roof structure, and a fixed part floor structure;
a rear body module detachably coupled to a rear part of the under body and the front body module, wherein the rear body module is a variable part having any predetermined shape of a plurality of predetermined shapes and comprises a variable part side structure, a variable part roof structure, and a variable part floor structure;
a fixed part joint beam connected to the front body module;
a variable part joint beam connected to the rear body module; and
a joint unit comprising a block, wherein the fixed part joint beam and the variable part joint beam are inserted in the block in a front-to-back direction of the vehicle body, and the joint unit engages with the fixed part joint beam and the variable part joint beam.

17. The vehicle of claim 16, wherein each of the fixed part joint beam and the variable part joint beam comprises:
a body engage portion having a closed cross-section; and
a block engage portion that extends in a rib shape from the body engage portion to fit into the joint unit and engages with the joint unit.

18. The vehicle of claim 17, wherein the joint unit comprises:
a main joint block that connects the fixed part joint beam and the variable part joint beam in the front-to-back direction of the vehicle body; and
a corner joint block that connects an end of the fixed part joint beam and an end of the variable part joint beam in the front-to-back direction of the vehicle body.

19. The vehicle of claim 18, wherein:
the fixed part roof structure comprises a fixed part roof rail and a fixed part roof panel connected to each other;
the variable part roof structure comprises a variable part roof rail and a variable part roof panel connected to each other;
the body engage portion engages with the fixed part roof rail and the variable part roof rail through first fastening members; and
the main joint block, the block engage portion, the fixed part roof rail, the variable part roof rail, the fixed part roof panel, and the variable part roof panel are engaged through second fastening members.

20. The vehicle of claim 19, further comprising:
a roof weather strip mounted on roof flange portions disposed on each of the fixed part roof panel and the variable part roof panel; and
a roof molding member mounted between the fixed part roof panel and the variable part roof panel.
